(19) United States
(12) Patent Application Publication
(10) Pub. No.: US 2012/0255802 A1
(43) Pub. Date: Oct. 11, 2012

(54) Transport Cradle for a Skid-Supported Helicopter

(76) Inventor: Eric Anthony Hancock, Yorkshire (GB)

(21) Appl. No.: 13/394,782

(22) PCT Filed: Sep. 7, 2010
(86) PCT No.: PCT/GB2010/051486

§ 371 Date: May 23, 2012

(30) Foreign Application Priority Data
Sep. 10, 2009 (GB) 0915831.2

(51) Int. Cl. B62D 39/00; B60K 17/30

(52) U.S. Cl. 180/169; 180/252

(57) ABSTRACT

A transport cradle for a skid-supported helicopter having a pair of laterally spaced and generally parallel support skids. The cradle comprises a main frame (2, 102) comprising a pair of laterally spaced elongate support arms (4, 104) extending generally parallel to each other and a cross support (6, 106) coupling together first ends of the elongate arms (4, 104). Each support arm (4, 104) is coupled to a support wheel (12, 112) towards a second end. At least one clamp (24, 124) is coupled to each support arm (4, 104) to engage a respective helicopter skid after the cradle has been presented to a helicopter supported on the ground by its skids. A drive unit (8, 108) is coupled to the cross support (6, 106) at a pivot (10, 110) positioned between the elongate arms(4, 104), the drive unit (8, 108) including a steerable drive wheel (14, 114) and a second drive unit wheel (16, 116). The steerable wheel (14, 114) and the second drive unit wheel (16, 116) are located within the drive unit (8, 108) on either side of the pivot (10, 110). The main frame is supported by the support wheels (12, 112) and the pivot (10, 110) between the cross support (6, 106) and the drive unit (8, 108) in at least a first configuration.

This invention relates to a transport cradle for a skid supported helicopter, that is a helicopter having a pair of laterally spaced and generally parallel support skids.

In the design and manufacture of helicopters, reduction of weight is of paramount importance, given that the major part of the engine power is utilised to generate a sufficient lifting force by the rotor blades, and therefore any avoidable increase in “dead weight” of the helicopter represents a reduction in potential payload. This is particularly important in military and police applications, where on-board equipment, for example weaponry or surveillance equipment significantly increase the payload which the helicopter must lift.

It is therefore common practice to provide many types of helicopters with simple support skids, since this represents a substantial weight saving compared to a wheel-supported undercarriage to support the load of the helicopter on the ground.

However, while a helicopter is of course highly manoeuvrable in the air, it is a particularly awkward craft to handle and manoeuvre on the ground when it is supported by simple skids. Frequently, small helicopters have to be physically man-handled, when they are required to be moved from the place where they have landed, for example to move the craft into a hanger. This is arduous work, and often is the cause of personal injury.

European patent number EP-0907558-B1 discloses a transport cradle for a skid-supported helicopter having a pair of laterally spaced and generally parallel support skids. The cradle comprises a main frame supported by transport wheels. The main frame comprises a pair of laterally spaced elongate supports extending generally parallel to each other. The supports are arranged to engage and to lift a respective helicopter skid after the cradle has been presented to a helicopter supported on the ground by its skids. The spacing apart of the supports may be adjusted to correspond with the spacing apart of the helicopter skids. Clamps are provided on each support to engage and to clamp a respective helicopter skid to the support. A cross member transport wheel arrangement includes a power module driving a trolley wheel is provided. The driven trolley wheel is steerable and operable by a pedestrian operator via a tiller handle so that the drive and steering of the cradle can be controlled by the operator.

The cradle disclosed in EP-0907558-B1 thus comprises a U-shaped frame arranged to be presented to the helicopter skids by being driven around the helicopter with the support arms located outside of the helicopter skids. The skids are then engaged by the clamps and the helicopter lifted from the ground. The driven trolley wheel and support wheels at the ends of the support arms allow the helicopter, supported by the cradle, to be driven to its new location.

The cradle disclosed in EP-0907558-B1 is generally only suitable for lifting helicopters when the cradle is presented to the helicopter from the front of the helicopter. This is because the driven trolley wheel and the steering tiller handle for the pedestrian operator are positioned centrally between the support arms. Consequently, if an attempt is made to present the cradle to the helicopter from the rear of the helicopter, the tail of the helicopter impedes access.

It is desirable to provide a transport cradle for a skid supported helicopter which may be used to lift and transport a helicopter when presented to the helicopter from the front or from the rear of the helicopter.

It is an object of the present invention to obviate or mitigate one or more of the problems associated with the prior art, whether identified herein or elsewhere.

According to a first aspect of the present invention there is provided a transport cradle for a skid-supported helicopter having a pair of laterally spaced and generally parallel support skids, the cradle comprising: a main frame comprising a pair of laterally spaced elongate support arms extending generally parallel to each other and a cross support coupling together first ends of the elongate arms, each support arm being coupled to a support wheel towards a second end; at least one clamp coupled to each support arm to engage a respective helicopter skid after the cradle has been presented to a helicopter supported on the ground by its skids; and a drive unit coupled to the cross support at a pivot positioned between the elongate arms, the drive unit including a steerable drive wheel and a second drive unit wheel, the steerable wheel and the second drive unit wheel being located within the drive unit on either side of the pivot; wherein the main frame is supported by the support wheels and the pivot between the cross support and the drive unit in at least a first configuration.

An advantage of the first aspect of the present invention is that because the drive unit comprises a steerable drive wheel which is offset to one side of the cradle, the central portion of the drive unit can have a low profile. Consequently, the drive unit is able to fit underneath the tail of most skid-supported helicopters when the cradle is presented to the helicopter from the rear of the helicopter. The second drive unit wheel may comprise a freely rotating castor wheel so that the weight of the helicopter is evenly transferred to the ground along the length of the drive unit and weight transferred from the main frame to the drive unit through the pivot is supported.

The main frame is pivotally coupled to the drive unit, which effectively causes the main frame, and thus the helicopter, to be supported at three points (the two support wheels and the pivot, which in turn transfers and distributes the weight of the helicopter to the steerable drive wheel and the rotating castor). It will be understood by the skilled person that when the main frame is supported on a horizontal surface the pivot axis extends generally parallel to the horizontal axis. Preferably the pivot axis extends between the elongate support arms, and more preferably the pivot axis extends parallel to the support arms and generally equidistant from the support arms. The drive unit comprises a steerable drive wheel and a second drive unit wheel positioned on either side of the pivot. The second drive unit wheel may not be driven, and may simply comprise a freely rotating castor wheel. Specifically, the pivot axis extends through the drive unit and effectively splits the drive unit into two parts, with one wheel being provided in each part. If the pivot were not present, and the transport cradle were supported by four wheels (the driven wheel and the castor wheel coupled directly to the main frame cross support, and support wheels at the other ends of each support arms) then in the event of uneven ground either one wheel would be lifted off the ground or the cradle would twist. Consequently, transport cradles in accordance with the present invention can traverse uneven ground without risking transferring a twisting force to the helicopter skids through the support arms, and thus avoiding the risk of damaging the helicopter.

The second drive unit wheel may comprise a freely rotating castor wheel.

Each support wheel may be rotatable between a first configuration in which the wheel runs generally parallel to the support arm and a second configuration in which the wheel runs generally perpendicular to the support arm.

The support arms may be coupled at the first ends to short leg inserts extending transverse to the axis of the support arms and arranged to slide within tubular ends of the cross support, the cross support further comprising rams arranged to slide the short leg inserts inwardly and outwardly such that sliding the short leg inserts within the cross support adjusts the distance between the support arms.

The transport cradle may further comprise a teeter arm coupled to each support arm, the teeter arms supporting the clamps, and a linkage between each teeter arm and the corresponding support arm arranged to allow the teeter arm to be raised and lowered relative to the support arm. Each linkage may comprise an upright post coupled to the support arm, each teeter arm being coupled to the post such that the teeter arm can rotate about the post bringing the teeter arm into or out of alignment with the corresponding support arm, the linkage further comprising a jack to lift the teeter arm along the axis of the post. Each teeter arm may support at least one pair of clamps spaced apart along the teeter arm and positioned either side of the linkage. Each clamp may further comprise a clamp roller such that when the teeter arm is lowered the roller engages the ground to space the clamp apart from the ground, for instance by approximately 5 mm, as the teeter arm slides perpendicular to the longitudinal axis of the support arms.

Alternatively the transport cradle may further comprise a teeter arm coupled to each support arm, the teeter arms supporting the clamps, and a linkage between each teeter arm and the corresponding support arm comprising an upright post coupled to the support arm, each teeter arm being coupled to the post such that the teeter arm can rotate about the post bringing the teeter arm into or out of alignment with the corresponding support arm.

Each teeter arm may support at least one pair of clamps spaced apart along the teeter arm and positioned either side of the linkage.

The support wheels may be retractable such that when the transport cradle is in a first configuration the support wheels are in a ground engaging position in which the main frame is supported by the support wheels and the pivot between the main frame and the drive unit and when the transport cradle is in a second configuration the support wheels are in a raised position in which the main frame is supported by side rollers coupled to the support arms and the pivot between the main frame and the drive unit to allow lateral movement between the support arms towards and away from one another.

Each teeter arm may further comprise at least one clamp roller such that when the support wheels are in the raised position the main frame is supported on the ground by the side rollers, the clamp rollers prevent contact between the clamps and the ground, for instance preserving a minimum separation of approximately 5 mm. When the support wheels are in the ground engaging position both the side rollers and the clamp rollers may be out of contact with the ground.

According to a second aspect of the present invention there is provided a transport cradle for a skid-supported helicopter having a pair of laterally spaced and generally parallel support skids, the cradle comprising: a main frame comprising a pair of laterally spaced elongate support arms extending generally parallel to each other and a cross support coupling together first ends of the elongate arms, each support aim being coupled to a support wheel towards a second end; a drive unit coupled to the cross support, the drive unit including a steerable drive wheel such that the main frame is supported by the support wheels and the steerable drive wheel; a teeter arm coupled to each support arm; a linkage between each teeter arm and the corresponding support arm arranged to allow the teeter arm to be raised and lowered relative to the support arm; and at least one clamp coupled to each teeter arm to engage a respective helicopter skid after the cradle has been presented to a helicopter supported on the ground by its skids.

An advantage of the second aspect of the present invention is that because the teeter arms may be raised and lowered relative to the main frame, the main frame may be relatively simple as it is not necessary for the main frame to change height in order to lift the helicopter. Rather, the cradle may be driven into position with the support arms surrounding the helicopter skids and the teeter arms lowered down to ground level. The clamps may then be opened and the support arms brought in towards the skids until the clamps engage the skids. The clamps may then be closed over the skids to secure the clamps to the skids. The teeter arms may then be raised to lift the helicopter. Advantageously, in embodiments of the second aspect of the invention the teeter arms can rotate relative to the support arms to allow the clamps to be correctly positioned with the helicopter skids in the event that the cradle is misaligned with the skids or the skids are not exactly parallel with one another (that is, the skids of the helicopter are “toe in” or “toe out”).

Each linkage may comprise an upright post coupled to the support arm, each teeter arm being coupled to the post such that the teeter arm can rotate about the post bringing the teeter arm into or out of alignment with the corresponding support arm, the linkage further comprising a jack to lift the teeter arm along the axis of the post.

Each teeter arm may support at least one pair of clamps spaced apart along the teeter arm and positioned either side of the linkage.

Each clamp may further comprise a clamp roller such that when the teeter arm is lowered the roller engages the ground to preserve a minimum separation between the clamp and the ground to prevent damage to the clamp as the teeter arms raise and lower perpendicular to the longitudinal axis of the support arms.

The support arms may be coupled at the first ends to short leg inserts extending transverse to the axis of the support arms and arranged to slide within tubular ends of the cross support, the cross support further comprising rams arranged to slide the short leg inserts inwardly and outwardly such that sliding the short leg inserts within the cross support adjusts the distance between the support arms.

Each support wheel may be rotatable between a first configuration in which the wheel runs generally parallel to the support arm and a second configuration in which the wheel runs generally perpendicular to the support arm.

According to a third aspect of the present invention there is provided a transport cradle for a skid-supported helicopter having a pair of laterally spaced and generally parallel support skids, the cradle comprising: a main frame comprising a pair of laterally spaced elongate support arms extending generally parallel to each other and a cross support coupling together first ends of the elongate arms, each support arm being coupled to a support wheel towards a second end; at least one clamp coupled to each support arm to engage a respective helicopter skid after the cradle has been presented to a helicopter supported on the ground by its skids; and at least one steerable drive wheel coupled to the cross support; wherein the main frame is supported by the support wheels and the pivot between the cross support and the drive unit; and wherein each support wheel may be rotatable between a first configuration in which the wheel runs generally parallel to the support arm and a second configuration in which the wheel runs generally perpendicular to the support arm.

An advantage of the third aspect of the present invention is that when in the first configuration the transport cradle may be used to transport a supported helicopter in a direction extending generally parallel to the support arms. The steerable drive wheel allows the helicopter to be turned, and if the drive wheel is turned to 90° relative to the support wheels the helicopter can be rotated through a very small turning circle: substantially turning on the spot. When in the second configuration, by aligning the drive wheel with the support wheels a helicopter can be manoeuvred sideways. Slight changes in trajectory can be achieved by turning the drive wheel relative to the support wheels, for instance by up to +/−5°.

The drive unit may further comprise a power module arranged to drive the steerable drive wheel.

The transport cradle may further comprise a control panel coupled via a wired or a wireless communications link to the drive unit, the control panel comprising control means arranged to allow an operator to control the direction and speed of the steerable drive wheel.

A transport cradle according to embodiments of the present invention can be readily moved over the ground to a standing helicopter, and can then be manoeuvred so as to approximately line up the support arms alongside the outside of the respective skids when the cradle is presented to the helicopter from the front or from the rear. The clamps are then operated to engage and to clamp the skids to the supports, and to lift the skids off the ground. The cradle can then be moved over the ground powered by the drive wheel to move the helicopter to a required new position, for instance inside a hanger.

The present invention will now be described, by way of example only, with reference to the accompanying drawings, in which:

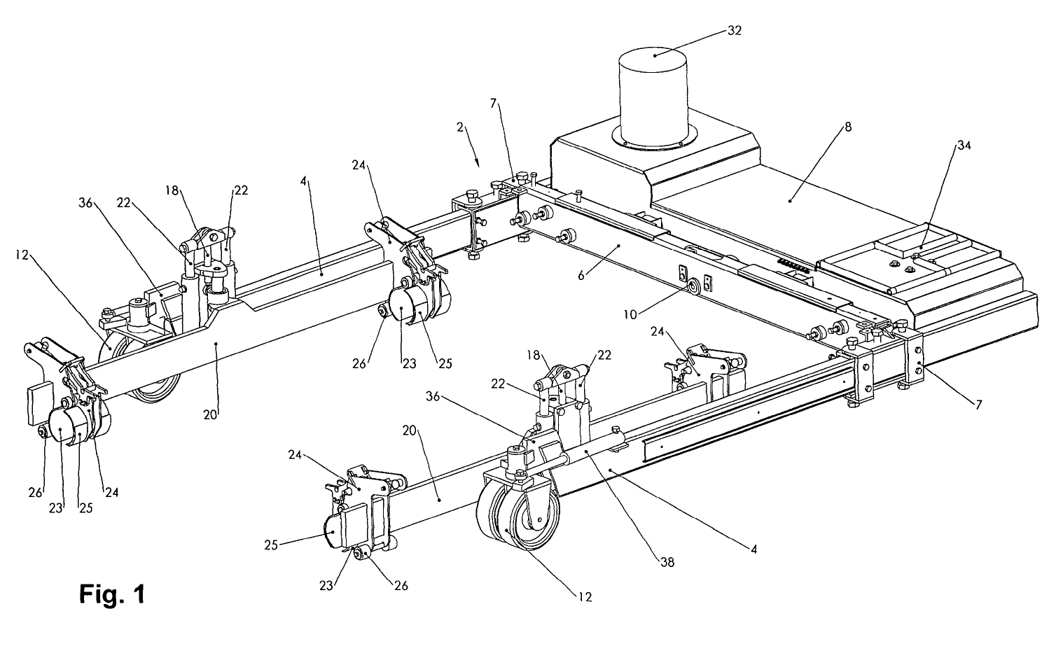

FIG. 1 is a perspective illustration partially from above of a transport cradle in accordance with a first embodiment of the invention;

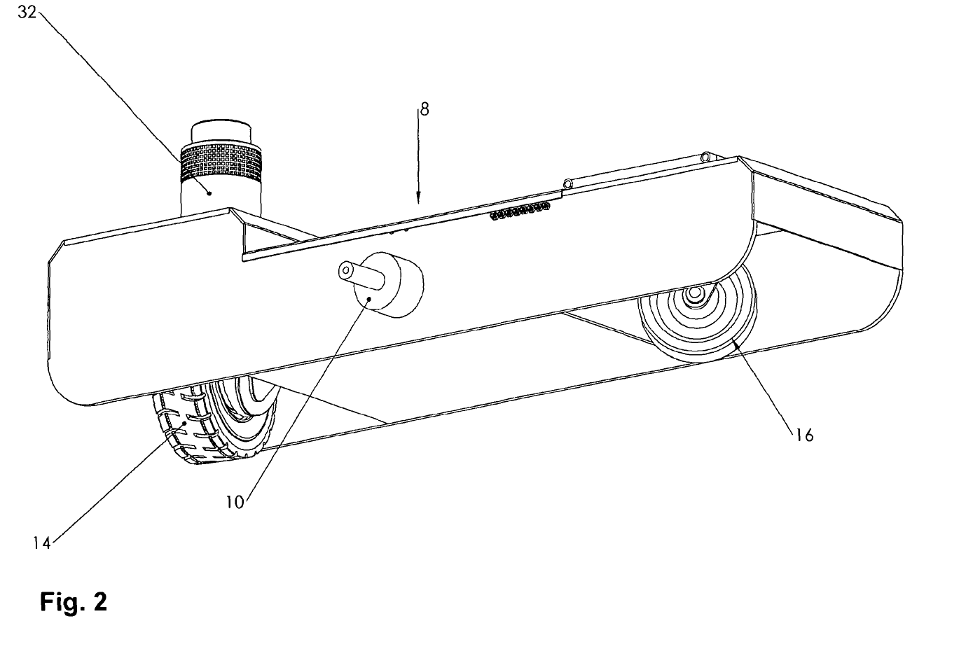

FIG. 2 is an enlarged perspective illustration of the underside of the drive unit of the transport cradle of FIG. 1, decoupled from the main frame;

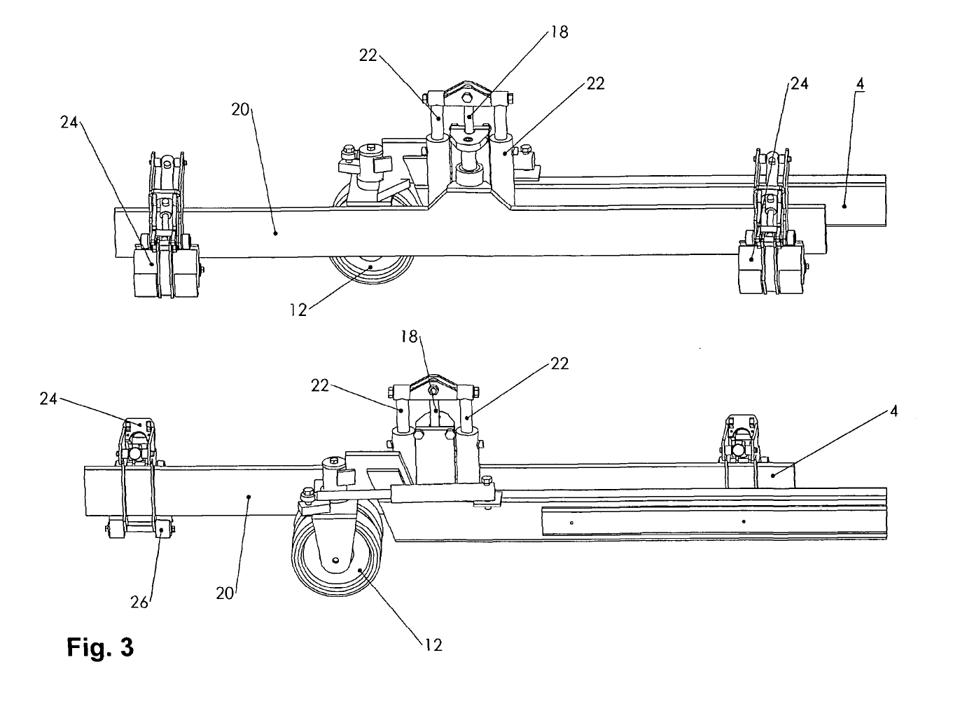

FIG. 3 illustrates part of the transport cradle of FIG. 1 showing the teeter arms and their connection to the support arms and the support wheels in a first configuration;

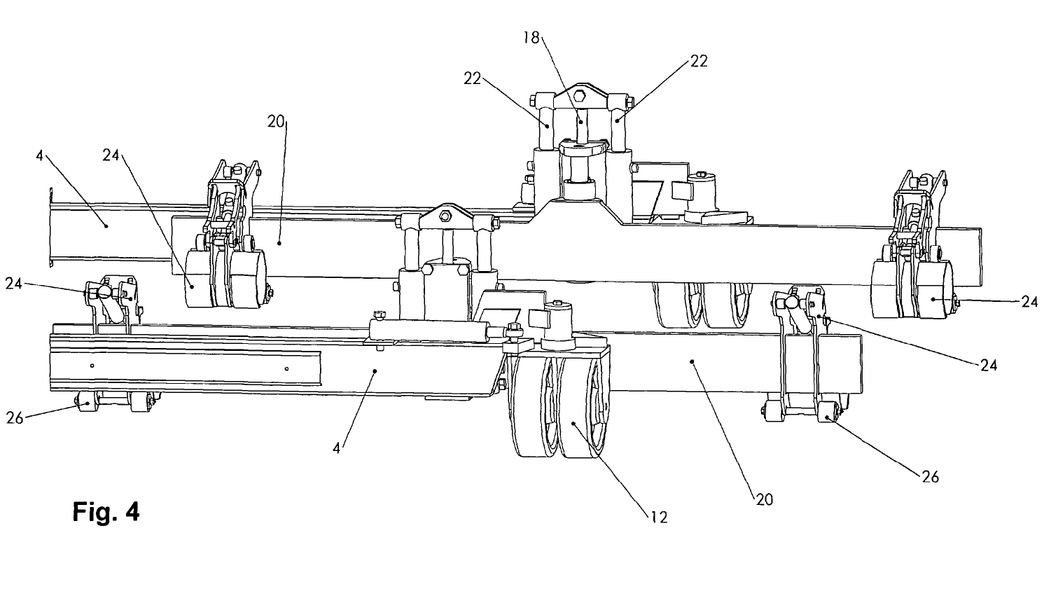

FIG. 4 illustrates part of the transport cradle of FIG. 1 showing the teeter arms and their connection to the support arms and the support wheels in a second configuration;

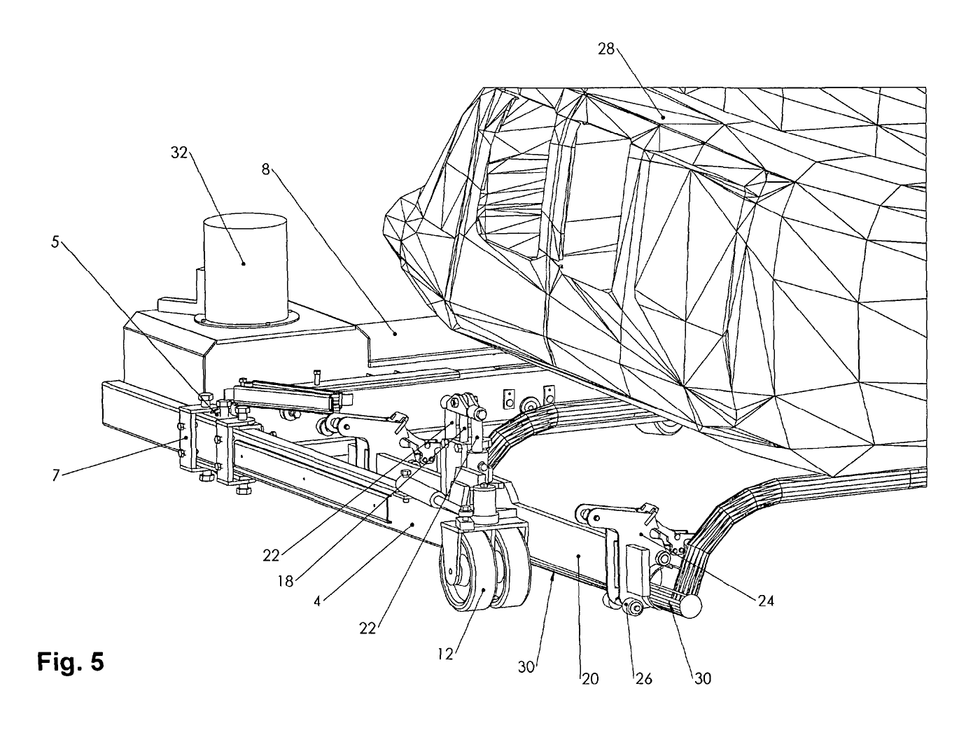

FIG. 5 illustrates the transport cradle of FIG. 1 supporting a skid-mounted helicopter;

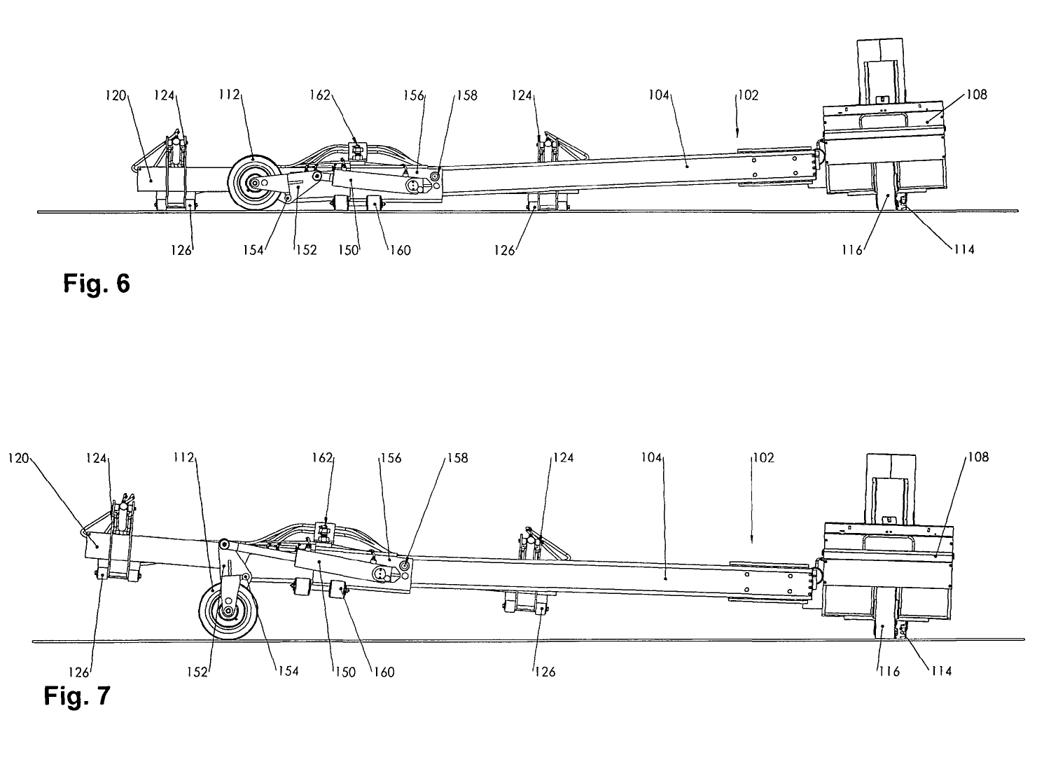

FIGS. 6 and 7 illustrates side views of a transport cradle in accordance with a second embodiment of the present invention in first and second configurations respectively; and

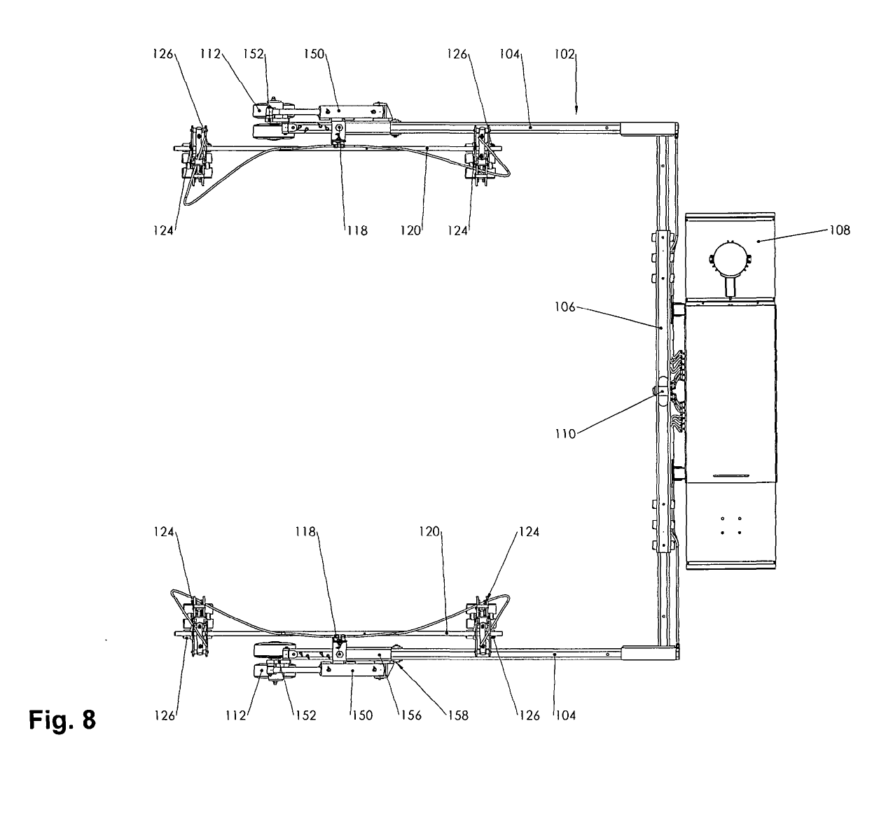

FIG. 8 is a plan view of the transport cradle of FIGS. 6 and 7.

Referring now to the drawings, there will be described a first embodiment of a helicopter transport cradle according to the invention. As can be seen from the perspective illustration of FIG. 1, the transport cradle comprises a main frame 2 which is generally U-shaped when viewed from above. The main frame 2 comprises a pair of generally parallel elongate support arms 4 and a cross support 6. The support arms 4 are coupled at first ends to the cross support 6 by short leg inserts 5 which are arranged to slide within and parallel to the cross support 6 such that they telescope from the end of the cross support 6. The short leg inserts 5 are not visible in FIG. 1, but are visible in FIG. 5. The short leg inserts 5 are coupled to the support arms 4 by brackets 7, such that the short leg inserts 5 extend from the support arms 4 at approximately 90° (and so the support arms 4 extend at 90° to the cross support 6). The cross support 6 is tubular, at least in its end portions, and the short leg inserts 5 extend into the ends of the cross support 6 such that they can slide inwardly and outwardly. The cross support 6 further contains internal hydraulic rams (not visible) arranged to act upon each respective short leg insert 5 so as to move the short leg insert 5 inwards and outwards. It will be readily apparent to the appropriately skilled person that any other known mechanism may be used to slide the short leg inserts 5 within the cross support 6. Each short leg insert 5 may be moved independently of the other. Moving the short leg inserts 5 adjusts the gap between the support arms 4 and allows the support arms 4 to be moved towards or away from the skids of a helicopter, and to accommodate different sizes of helicopter.

The cross support 6 is coupled to a drive unit 8 by a pivot 10. The main frame 2 is thus able to pivot relative to the drive unit 8 about the axis of the pivot 10. The axis of the pivot 10 is generally parallel to the longitudinal axis of the support arms 4, and the pivot 10 is located approximately centrally between the support arms 4.

The support arms 4 are supported at their second ends by support wheels 12. Each support arm 4 may be supported by a pair of coupled parallel support wheels 12. Referring to FIG. 2, the drive unit 8 is supported by a steerable drive wheel 14 and a freely rotating castor wheel 16. In alternative embodiments of the invention the castor wheel 16 may be replaced by a second driven wheel. The steerable drive wheel 14 and the freely rotating castor wheel 16 are located on opposite sides of the pivot 10 to support weight transferred to the pivot 10 from the main frame 2. Thus, the main frame 2 is supported by three points spaced apart in a triangle: the support wheels 12 coupled to each support arm 4 and the pivot 10 between the main frame 2 and the drive unit 8. The pivot 10 between the main frame 2 and the drive unit 8 allows the drive unit 8 to rotate relative to the main frame 2 to accommodate uneven ground, without any of the wheels leaving contact with the ground. Effectively, as the drive unit 8 pivots relative to the main frame 2 one of the steerable drive wheel 14 and the castor 16 tilts up relative to the plane of the main frame 2 and the other tilts down, though neither wheel moves relative to the drive unit 8. Due to the pivot 10, in the event of uneven ground the main frame 2 is not subjected to a twisting force, and consequently no such force is transferred to the skids of a helicopter.

Referring back to FIG. 1, each support arm 4 is coupled to an upright post 18. A teeter arm 20 is in turn coupled to each post 18. The teeter arms 20 are elongate and extend from the posts 18 either side of the posts 18 and run generally parallel to the support arms 4, though they can rotate relative to the support arms 4 about the posts 18. Jacks 22 are provided upon each support arm 4 to raise or lower the teeter arms 20 relative to the support arms 4. When a teeter arm 20 is raised or lowered, the coupling to the post 18 slides along the post 18. Each teeter arm 20 further comprises first and second spaced apart clamps 24. It will be appreciated that in alternative embodiments of the invention there may be any number of clamps spaced apart along the teeter arms to distribute the weight of the helicopter. For instance, there may be four or six clamps distributed along each teeter arm.

The clamps 24 are arranged to engage the skids. Each clamp 24 comprises a fixed jaw 23 and a moveable jaw 25. When the skids of a helicopter are resting on the ground the jaws of each clamp 24 are arranged to come up to and partially pass over a skid and then the clamp jaws are closed to encircle the skid. The clamps 24 further comprise clamp rollers 26 arranged to roll along the ground when the teeter arms 20 are fully lowered. The clamp rollers 26 are coupled to the fixed jaws 23. When the teeter arms 20 are lowered therefore, the rollers 26 space the teeter arms 20 apart from the ground, to accommodate uneven surfaces between the support arms 4, and allow for approximately 5 mm of ground clearance underneath the bottom edge of the fixed jaws 23 to prevent the clamps 24 catching upon the ground. The clamp rollers 26 are formed from a nylon sleeve arranged to rotate about a metal pin. As the rollers do not support the weight of the main frame 2 or the helicopter there is no necessity for them to include separate bearings. As the clamp rollers 26 wear their position relative to the clamps 24 may be adjusted so at to preserve the predetermined separation between the clamps 24 and the ground.

The procedure for lifting a helicopter is as follows: firstly the cradle is moved into position such that the support arms 4 extend generally parallel to the skids and are positioned outside of the skids. The gap between the support arms 4 may be adjusted so that the clamps 24 are positioned close to the helicopter skids. The teeter arms 20 are then lowered until the clamp rollers 26 come into contact with the ground such that the clamps 24 are at the correct height to engage the helicopter skids and remain spaced apart from the ground to prevent damage to the clamps. Each clamp 24 is then opened. The fixed jaw 23 remains stationary and the moveable jaw 25 is lifted upwards by a hydraulic ram. The fixed jaw therefore provides an open mouth facing towards the helicopter skid. The support arms 4 (and hence the teeter arms 20 and the clamps 24) are then brought inwards towards the skids by withdrawing the short leg inserts 5 into the cross support 6 until the fixed jaws 23 engage the outside surface of the skid. Preferably the support arms 4 are moved one at a time. Once the fixed jaws 23 of each clamp 24 attached to a teeter arm 20 are in contact with the outside edge of the skid, the moveable jaws 25 are closed such that the skid is substantially encircled by the jaws of the clamp. When the helicopter is resting upon the ground, the weight of the helicopter is transferred to the ground through a wear strip running along the underside of the skid. The wear strip comprises approximately one eighth of the diameter of the skid. The clamps 24 when closed do not fully encircle the skids. Rather a gap is left at the top and the bottom, which ensures that the action of closing the clamps 24 does not force the tips of the jaws under the skid. The teeter arms 20 may then be raised and the tips of the jaws of the clamps underneath the skid come into contact with the wear strip such that the weight of the helicopter is transferred to the clamps, and hence the cradle, via the wear strips. As the clamps act upon the portion of the skids arranged to support the weight of the helicopter on the ground, the risk of damage to the helicopter skids is reduced.

As the teeter arms 20 are coupled to the support aims 4 at a central position between the clamps 24, the support arms 4 may be shorter than the furthest end of the teeter arms 20 from the drive unit 8. That is, the teeter arms 20 may extend further from the drive unit 8 than the ends of the support arms 4 and the support wheels 12. Furthermore, because the drive unit 8 is smaller, and in particular shorter than certain previous helicopter transport cradles, the drive unit 8 may in use be positioned further underneath a helicopter, and closer to the skids, again reducing the length of the support arms 4. In one embodiment of the present invention the total length of the cradle is approximately 4 m, though it will be appreciated that the dimensions of the cradle may vary according to the size of the type of helicopter to be lifted. The reduction in length of the support arms 4 assists in reducing the overall size of the cradle. Furthermore, when the cradle is disassembled for delivery, the shorter support arms 4 allow for a smaller crate to contain all of the parts of the cradle. As noted above, the short leg inserts 5 are secured to the support arms 4 by brackets 7. This also allows the cradle to be smaller when disassembled for delivery.

As discussed above, the gap between the support arms 4 may be adjusted by independently moving each support arm 4, by sliding the short leg insert 5 in or out of the cross support 6 under the action of the hydraulic rams within the cross support. In order to engage and lift a helicopter the gap between the support arms 4 is increased so that the gap between the teeter arms 20 is greater than the gap between the outside of the helicopter skids. The cradle is then driven around the helicopter, approaching from either the front or from the rear, such that the support arms 4, and hence the teeter arms 20, are generally parallel to the helicopter skids around the outside of the helicopter.

The teeter arms 20 are then lowered by operating jacks 22 until the rollers 26 make contact with the ground to maintain a minimum separation between the clamps 24 and the ground.

The gap between the support arms 4 is then reduced such that the support arms 4 are brought together and the fixed jaws 23 of the clamps 24 are positioned up to and touching the skids with the clamps in the open position. In the event of misalignment of the teeter arms 20 and the skids, the teeter arms 20 can rotate about posts 18 so that the misalignment is corrected and the clamps 24 are positioned close to the skids. The moveable jaws 25 of the clamps 24 may then be closed around the helicopter skids and the teeter arms 20 raised thereby lifting the helicopter.

Referring to FIG. 5, this illustrates a helicopter 28 lifted from the ground by a transport cradle in accordance with an embodiment of the present invention. Skids 30 are engaged by clamps 24 and the teeter arms raised up until the skids 30 are no longer in contact with the ground and the weight of the helicopter 28 is transferred via the skids to the clamps 24, and then in turn to the main frame 2 of the cradle. The ability of the teeter arms 20 to rotate relative to the support arms 4 allows the cradle to automatically adjust to different helicopter skid configurations, for instance “toe in” and “toe out” skids. Furthermore, if the transport cradle is out of alignment with the helicopter, for instance by up to 20°, then the teeter arms will automatically adjust for this. As an out of alignment helicopter is lifted clear of the ground the teeter arms 20 will slowly rotate about posts 18 until the helicopter is aligned with the support arms 4. During the rotation of the helicopter, the skids may shift slightly within the clamps 24.

Referring now to FIG. 3, this illustrates the support wheels 12 of the support arms 4 in a first configuration. In the first configuration the support wheels 12 are locked in position such that they run generally parallel to the support arms 4 (that is, the axis of rotation of the support wheels 12 is perpendicular to the longitudinal axis of the support arms). The first configuration allows the transport cradle to be driven backwards and forwards (that is, parallel to the axes of the support arms) and steered by rotating the driven wheel 14 underneath the drive unit 8. The castor wheel 16 is free to continuously rotate as required and serves only to support the second end of the drive unit 8. The driven steerable wheel 14 is positioned to one side of the drive unit so as to reduce the height of the central portion of the drive unit to avoid conflict with a helicopter tail. The drive for wheel 14 comprises a motor, gearbox and brake with a separate power steering motor which drives wheel 14 via a chain. The drive components are housed within a vertical stack 32, as illustrated in FIG. 2.

In the first configuration the drive wheel 14 may be driven in either direction and freely rotated to allow the cradle to be turned. That is, the drive wheel 14 may be rotated through 360° while also being driven in either direction, which allows the transport cradle to be smoothly turned in either direction and also to be changed from forward to reverse in a continuous smooth movement. As the drive wheel 14 can be turned by 90° relative to the longitudinal axes of the support arms 4 the transport cradle can be rotated in a tight turning circle, substantially turning a supported helicopter on the spot.

Referring to FIG. 4, this illustrates the support wheels 12 of the support arms 4 in a second configuration. In the second configuration the support wheels 12 are locked in position such that they run generally perpendicular to the support arms 4. As illustrated in FIG. 1, each support wheel 12 is fixedly coupled to a jaw 36, which in turn is pivotally coupled to the support arm 4. A hydraulic jack 38 is provided to act upon the mechanism to rotate the wheels 12 between the first configuration and the second configuration (that is, to change the axis of rotation of the support wheels 12).

In the second configuration, the support wheels 12 can support the support arms 4 while the cross support 6 is adjusted in length to bring the support arms 4 together or to space the support arms 4 apart. Furthermore, when the support wheels 12 are in the second configuration, driven wheel 14 may also be rotated such that it runs generally perpendicular to the axes of the support arms 4, thereby allowing the cradle, and hence a supported helicopter, to be transported sideways. When transporting a helicopter sideways, the driven wheel may be steered slightly, for instance by up to +/−5°, preferable 1-2° in order to adjust the trajectory of the helicopter.

Although not illustrated, the transport cradle of the present invention may be controlled by a pedestrian operator via a control panel coupled to the drive unit 8 along an umbilical cable. Alternatively, the cradle may be controlled wirelessly using a control panel controlling the cradle via a wireless communications link. The appropriately skilled person will be aware of suitable wireless communication protocols and control techniques which may be used. The control panel allows the operator to control the direction and speed of the driven wheel 14, the orientation of the support wheels 12 between the first and second configurations, the contracting and expansion of the support arms 4 about a helicopter, the raising and lowering of the teeter arms 20 along posts 18 and the operation of the clamps 24. Preferably the driven wheel 14 is driven by an electric motor and the remaining components are powered hydraulically. The battery for the motor, the hydraulic power pack and associated valves and electrical components are located within the body of the drive unit 8. The drive unit 8 may further comprise a fold-down ride-on platform 34 allowing the operator to stand on the cradle while transporting a helicopter as an alternative to walking alongside the helicopter.

A helicopter transport cradle according to embodiments of the present invention can be utilised as ground handling unit for all types of skid mounted helicopters. It has been designed to give the operator maximum control, with minimum effort, affording maximum protection for both the payload, and the operator.

Drive may be from an electric motor and reduction box, controlled by a combined directional and proportional switch, through an integrated speed control board, enabling the unit to be capable of adjustment from moving from a slow “snail pace” to a fast walking speed of 2.2 m/s (5 mph), or faster.

The width adjustment of the supports may be hydraulic, using a typical telescopic movement, and each support is controlled individually, to bring the support generally alongside the respective skid of the helicopter, regardless of whether it is “toe in” or “toe out”. The rotating teeter arms allow the respective skids to be engaged and firmly clamped to the support arms, prior to raising of the support arms relative to the ground.

An important aspect of the transport cradle is that it can pick up a helicopter by travelling down both sides of the helicopter, approaching from the front or from the rear, on the outsides of the skids, rather than down the centre. This is done for two reasons.

First of all, from the safety point of view, by approaching and picking up a helicopter in this way, effectively the main frame is supported at three points in a triangular pattern extending around the outside of the helicopter skids and surrounding the centre of gravity of the helicopter. This supports the helicopter with such stability that even quick turns, and sudden directional changes, can be executed without risk of loss of stability (subject to structural surroundings).

Secondly, it gives convenience to the helicopter operator. By using this method, it means that expensive accessories, such as cameras, search lights, belly hooks and weapon cradles can all be catered for, without fear of damage caused by the handling unit, since such accessories are normally supported in-board of the skids. Also, the facility for adjusting the separation of the support arms and the teeter arms and clamps allows the cradle to be used with different designs of helicopters automatically, whilst being in full view of the operator.

Referring now to FIGS. 6 to 8, these illustrate a transport cradle in accordance with a second embodiment of the invention. Features of the second embodiment which are generally the same as those of the first embodiment are identified by reference numbers which have been incremented by 100. The second embodiment illustrated in FIGS. 6 to 8 is in large part the same as the first embodiment illustrated in FIGS. 1 to 5, and shows a generally similar main frame 102 formed from support arms 104 and cross support 106. The main frame 102 is coupled to the same form of drive unit 108. Where there are differences, this lies in the way in which the weight of the helicopter is lifted, as will now be described.

For the first embodiment helicopter lifting is achieved by jacks 22 lifting up the teeter arms 20 relative to the support arms 4, which remain at a static height above the ground, supported by the support wheels 12. However, for the second embodiment, the teeter arms 120 cannot be raised or lowered relative to the support arms 104. As for the first embodiment, the teeter arms 120 are coupled to the support arms 104 via a pivotal connection about a vertical post 118. This allows the teeter arms 120 to rotate out of alignment with the support arms 104 to accommodate misalignment of the main frame 102 and different designs of helicopter skids. However, the central point of the teeter arms 120 which couples to posts 118 remains fixed relative to the height of the support arms 104. That is, the teeter arms 120 cannot be raised and lowered relative to the support arms The coupling to the support arms 104 also allows the ends of the teeter arms 120 to tilt up and down relative to the longitudinal axis of the support arms 104, as can be seen by comparison of FIGS. 6 and 7, and as described in greater detail below. That is, the teeter arms 120 are coupled to the support arms 104 via a coupling which allows pivoting about two orthogonal axes, specifically a first, generally vertical axis (vertical post 118) which is perpendicular to the plane of the main frame defined by the support arms and the cross support and a second axis (to be described below) which is generally parallel to the cross support. The extent of pivoting about vertical post 118 is limited by contact between the teeter arms and the support arms, or otherwise limited by end stops.

To lift the teeter arms 120 each support wheel 112 is arranged to raise and lower under the action of a hydraulic ram 150. Specifically, a lever 152 is coupled to the support arm 104 at pivot 154. On one side of pivot 154, the support wheel 112 is coupled to the lever 152, and on the other side of the pivot 154 is coupled the hydraulic ram 150. Expansion or contraction of the hydraulic ram causes the lever 152 to rotate about the pivot 154, which raises or lowers support wheel 112. The other end of the hydraulic ram 150 is coupled to the support arm 104 via an end tube assembly 156, which comprises a sleeve extending about the support arm 104. The end tube assembly 156 has a larger cross section than the support arm 104 such that it can rock up and down relative to the support arm 104. The end tube assembly 156 is coupled to the support arm at a pivot 158, which extends parallel to the cross support 106. The vertical post 118 (and hence the teeter arm 120) is rigidly fixed to the end tube assembly 156. Consequently, as the end tube assembly 156 rocks up and down relative to the support arm 104 the teeter arm 120 can pivot up and down relative to the support arm 104, as described above, which allows the teeter arm 120 to be accurately positioned relative to the ground when the support wheel 112 is raised, as will be described below. Rotational movement of the end tube assembly 156 about the support arms 104 may be limited by manually adjusting an end tube assembly height adjuster bolt 162. This may be necessary for front or tail heavy helicopters to ensure that the helicopter weight is lifted evenly.

FIG. 6 shows a first configuration in which the wheels 112 are raised up relative to the support arms 104. As for the first embodiment, clamp 124 are provided with clamp rollers 126, which serve to space the clamps 124 apart from the ground. As the support wheels are raised the clamp rollers 126 engage the ground and prevent contact between the clamps 124 and the ground. Depending upon which clamp roller 126 contacts the ground first, the end tube assembly 156 (and hence the teeter arm 120) may rotate about pivot 158 until both clamp rollers 126 on each teeter arm 120 are in contact with the ground. Unlike the first embodiment, the weight of the main frame 102 (other than that portion of the weight supported by the drive unit 108) is no longer supported by the support wheels 112. When the wheels 112 are raised the weight is transferred to side rollers 160. Side rollers are load bearing rollers, and may be formed from polyurethane sleeves and metallic ball bearings, with additional lubrication is required. When the wheels are raised the support arms can be brought together as described above by action of the hydraulic rams within the cross support 106 to present the support arms 104, and specifically the clamps 124 to the skids of the helicopter. Coupling of the clamps 124 to the helicopter skids is the same as for the first embodiment.

Once the clamps 124 have engaged the helicopter skids the support wheels 112 are lowered, which lifts the teeter arms 120 and hence the helicopter from the ground. The transport cradle can then be freely driven in the same way as for the first embodiment when the wheels 12 are running parallel to the support arms 4. Unlike the first embodiment, there is no necessity for support wheels 112 to be steerable as adjustment of the space between the support arms 104 is achieved when the rollers 126 are in contact with the ground. However, in certain further embodiments the transport cradle shown in FIGS. 6 to 8 may be further modified to allow the support wheels 112 when lowered to be rotated through 90° so as to allow a helicopter to be driven sideways.

A transport cradle in accordance with the second embodiment is driven to a helicopter resting upon its skids and manoeuvred so as to line up the support arms with the helicopter skids. The support wheels are then raised and the telescopic mechanism in the cross support activated so as to bring the clamps into close relationship with the skids with the support arms rolling upon the rollers on the teeter arms proximal to the clamps. Once the clamps have engaged the skids the support wheels can be lowered and the helicopter transported to its new position.

Further modifications to, and applications of, the present invention will be readily apparent to the appropriately skilled person without departing from the scope of the appended claims.

1. A transport cradle for a skid-supported helicopter having a pair of laterally spaced and generally parallel support skids, the cradle comprising:
a main frame comprising a pair of laterally spaced elongate support all is extending generally parallel to each other and a cross support coupling together first ends of the elongate arms, each support arm being coupled to a support wheel towards a second end;
at least one clamp coupled to each support arm to engage a respective helicopter skid after the cradle has been presented to a helicopter supported on the ground by its skids; and
a drive unit coupled to the cross support at a pivot positioned between the elongate arms, the drive unit including a steerable drive wheel and a second drive unit wheel, the steerable wheel and the second drive unit wheel being located within the drive unit on either side of the pivot;
wherein the main frame is supported by the support wheels and the pivot between the cross support and the drive unit in at least a first configuration.

2. A transport cradle according to claim 1, wherein the second drive unit wheel comprises a freely rotating castor wheel.

3. A transport cradle according to claim 1, wherein each support wheel is rotatable between a first configuration in which the wheel runs generally parallel to the support arm and a second configuration in which the wheel runs generally perpendicular to the support arm.

4. A transport cradle according to claim 1, wherein the support arms are coupled at the first ends to short leg inserts extending transverse to the axis of the support arms and arranged to slide within tubular ends of the cross support, the cross support further comprising rams arranged to slide the short leg inserts inwardly and outwardly such that sliding the short leg inserts within the cross support adjusts the distance between the support arms.

5. A transport cradle according to claim 1, further comprising a teeter arm coupled to each support arm, the teeter arms supporting the clamps, and a linkage between each teeter arm and the corresponding support arm arranged to allow the teeter arm to be raised and lowered relative to the support arm.

6. A transport cradle according to claim 5, wherein each linkage comprises an upright post coupled to the support arm, each teeter arm being coupled to the post such that the teeter aim can rotate about the post bringing the teeter arm into or out of alignment with the corresponding support arm, the linkage further comprising a jack to lift the teeter arm along the axis of the post.

7. A transport cradle according to claim 5, wherein each teeter arm supports at least one pair of clamps spaced apart along the teeter arm and positioned either side of the linkage.

8. A transport cradle according to claim 7, wherein each clamp further comprises a clamp roller such that when the teeter arm is lowered the clamp roller engages the ground before the corresponding clamp to preserve a minimum separation between the clamp and the ground to prevent damage to the clamp as the teeter arm slides perpendicular to the longitudinal axis of the support arms.

9. A transport cradle according to claim 1, further comprising a teeter arm coupled to each support arm, the teeter arms supporting the clamps, and a linkage between each teeter arm and the corresponding support arm comprising an upright post coupled to the support arm, each teeter arm being coupled to the post such that the teeter arm can rotate about the post bringing the teeter arm into or out of alignment with the corresponding support arm.

10. A transport cradle according to claim 9, wherein each teeter arm supports at least one pair of clamps spaced apart along the teeter aim and positioned either side of the linkage.

11. A transport cradle according to claim 1, wherein the support wheels are retractable such that when the transport cradle is in a first configuration the support wheels are in a ground engaging position in which the main frame is supported by the support wheels and the pivot between the main frame and the drive unit and when the transport cradle is in a second configuration the support wheels are in a raised position in which the main frame is supported by side rollers coupled to the support arms and the pivot between the main frame and the drive unit.

12. A transport cradle according to claim 9, wherein each clamp further comprises a clamp roller such that when the support wheels are in the raised position the clamp roller engages the ground before the corresponding clamp to preserve a minimum separation between the clamp and the ground to prevent damage to the clamp as the support arms towards and away from one another.

13. A transport cradle according to claim 12, wherein when the support wheels are in the ground engaging position the clamp rollers are out of contact with the ground.

14. A transport cradle according to claim 1, wherein the drive unit further comprises a power module arranged to drive the steerable drive wheel.

15. A transport cradle according to claim 1, further comprising a control panel coupled via a wired or a wireless communications link to the drive unit, the control panel comprising control means arranged to allow an operator to control the direction and speed of the steerable drive wheel.
